(19) United States
(12) Patent Application Publication
(10) Pub. No.: US 2010/0236284 A1
(43) Pub. Date: Sep. 23, 2010

(54) Preserving liquids in cryogenic processes

(75) Inventor: Denyse Claire DuBrucq, Cedarville, OH (US)

Correspondence Address: Denyse DuBrucq, 100 W. Elm Street, Cedarville, OH, 45314-8575, US

(73) Assignee: Denyse Claire DuBrucq Living Trust, Cedarville, OH (US)

(21) Appl. No.: 12/383,586

(22) Filed: Mar. 23, 2009

(51) Int. Cl. F25J 1/00; B01D 8/00

(52) U.S. Cl. 62/611; 62/55.5

(57) ABSTRACT

A trap system for cryogenic environments, which brings a gas to a body of the same material in liquid form, allows the liquefied material in the gas bearing tube to pass through a submerged trap combining the newly condensed liquid with that in the reserve. With this apparatus, for example, pure cold Nitrogen gas can be condensed and recycled in a system requiring cryogenic liquid Nitrogen to start the process. This trap system can also be applied to other gaseous materials stored cooled beyond the condensing temperatures. The trap system brings the newly condensed material into the vessel of already condensed material. The gas that has not condensed into liquid, in the case of Liquid Nitrogen, will release into the atmosphere. It is expected that all the gas of the other material will liquefy and be part of the stored liquid because it is stored below its liquefaction temperature—here using Liquid Nitrogen chambers surrounding the vessel of the liquefied material. Also included are means to maintain a clean reservoir of cryogenic liquids providing means to remove debris on the surface, floating within the liquid and at the bottom of the reservoir. And yet more, keeping the liquid form of material is protected from the gas state material to prevent more rapid evaporation.

### CROSS-REFERENCE TO RELATED APPLICATIONS

Hydrocarbon Harvesting from Coal, Shale, Peat, and Landfill Seams U.S. application Ser. No. 11/903,346, PCT/US2008/010744; and Hydrocarbon Harvesting from Methane Hydrate Deposits and Shale Seams, U.S. application Ser. No. 12/217,915 include aspects of this invention. Both patents and this application are DuBrucq inventions. The closest prior art application are liquefying Nitrogen in U.S. Pat. No. 7,086,251 of Mark Julian Roberts taking a huge apparatus and U.S. Pat. No. 7,024,835 of Villalobos, which takes a cold pure gas stream and requires compression of the gas before liquefication.

### BACKGROUND OF THE INVENTION

1. Field of the Invention

During cryogenic processing, materials are often liquefied for storage or for preserving the pure materials in gaseous state close to thermal liquefication. What is needed is a means to recycle pure Nitrogen and to separate the just reliquefied portion of that material so it can be included in the reservoir of the liquid state segment of that pure material. It requires a cryogenic tolerant motion to block the contamination of the gas portion from the liquid portion of the material. This invention provides this function and means to clean debris from a filled cryogenic reservoir and to separate out light gases.

2. Discussion of the Related Art

Two DuBrucq application Ser. Nos. 11/903,346 and 12/217,915, have exhaust material of pure gaseous Nitrogen, N₂, molecules at on or around −190° C. temperature. To simply lower the temperature to that of liquid Nitrogen, to −195.8° C., would preserve the pure Nitrogen as a liquid essentially saving having to purchase some of the Liquid Nitrogen needed for the process. What portion of the external purchase requirements will be eliminated by this process is yet to be determined. To this point, only elaborate machinery is used to liquefy Nitrogen, Oxygen and Natural Gases, as, for example, liquefying Nitrogen in U.S. Pat. No. 7,086,251 of Mark Julian Roberts and U.S. Pat. No. 7,024,835, Villalobos, where a cold pure gas stream needs compressed gas before liquefication.

### SUMMARY OF THE INVENTION

In accordance with one aspect of the invention, the Nitrogen gas exhaust pipe feeds pure Nitrogen at about −190° C. into a pipe at the surface of the Liquid Nitrogen in the reservoir of Liquid Nitrogen to lower the temperature of the gas to the liquefication temperature of −195.8° C. At a low point in the piping, traps are positioned to catch the newly liquefied Nitrogen. The pipe continues bending upward exhausting remaining gas above the surface of Liquid Nitrogen in the reservoir.

In another aspect of the present invention, after the pure Nitrogen gas in the pipe liquefies, it flows down a trap or series of traps, straight, solid walled, vertical pipes directed downwards further into the Liquid Nitrogen at the lowest area of the pipe.

In yet another aspect of the present invention, this trap has solid walls until it passes the bottom of its length and turns 180°. The parallel pipe section in the loop is pierced with holes allowing the newly liquefied Nitrogen to mix with that in the reservoir as it climbs to near the top of the trap pipe where solid pipe comprises the 90° elbow and crosspipe to flow into a “T” in the vertical pipe of the trap.

In yet another aspect of the present invention, this pipe circuit has a spaced bead chain of balls that fit within the pipe snugly enough to not allow the Liquid Nitrogen to back flow in the pipe, also preventing the chain connecting the beads from being passed over by the next ball in the bead chain. These balls often will bunch where junctions of pierced and solid wall sections of the pipe meet as they circle the trap.

In yet another aspect of the present invention, the trap entrance has a one-way flow valve to prevent backflow of the Liquid Nitrogen from the reservoir into the entry pipe for the gas phase Nitrogen.

In yet another aspect of the present invention, the bead balls are lighter in mass than the Liquid Nitrogen and float from the end of the solid “U” connection on the base of the trap to the return pipe running parallel with pierced sides allowing the light weight balls forced downward in the solid entry pipe to float upward as the Liquid Nitrogen enters the reservoir liquid.

In yet another aspect of the present invention, the chain distance between the ball beads is considerably longer than the distance of solid pipe leading from the end of the pierced pipe section to the trap entrance pipe allowing the difference in distance of pipe to carry the newly liquefied Nitrogen as the ball beads move around the loop of the trap.

In yet another aspect of the present invention, the exhaust pipe extension floats on the surface of the Liquid Nitrogen enabled by two ball joints allowing it to swivel to stay at the surface of the liquid and again to swivel so the traps are in a vertical configuration.

In yet another aspect of the present invention, the traps have a valve on the intersection of the exhaust pipe extension and the trap with a ball valve stopping flow from the trap to the exhaust pipe extension where the movement upward causes the ball to lock in the ring inside the top of the trap tube preventing Liquid Nitrogen flow upward.

As a result of this configuration, the liquid Nitrogen forming in the exhaust pipe extension into the bath of Liquid Nitrogen proceeds into the traps the weight of the liquid pushes the ball beads down the trap pipe and, as they return floating through the pierced pipe where the liquid Nitrogen or other frozen material passes into the reservoir, and then encountering the solid portion near the top of the parallel pipe, the ball moves the contained Liquid Nitrogen through the trap pulling newly liquefied Nitrogen from the exhaust pipe along with it. This limits liquid Nitrogen from the reservoir from entering the trap system to only that contained in the short pipe bends as the loop returns to the run down the trap portion. As the ball beads circulate around this trap system, the newly liquefied Nitrogen is pulled from the exhaust pipe extension into the reservoir of Liquid Nitrogen, recycling the purified gas from the processing system for use in the process.

In yet another aspect of the present invention, a cold sink is employed to bring the yet lower temperature of the Liquid Nitrogen in the bottom of the reservoir to help cool the exhaust pipe extension liquefying more of the Nitrogen than would happen with just the surface temperature of 195.8° C.

It is yet another aspect of the invention to care for the Liquid Nitrogen reservoir to first, allow any further light gas removal from the gas reservoir over the surface of the Liquid Nitrogen.

And yet another aspect of the invention has two methods to remove any accumulated debris from the cryogenic tank—use of a net shovel and use of a drop net, thus keeping the Liquid Nitrogen pure even with the reliquification.

In yet another aspect of this invention, this same trap system on an exhaust pipe entering a storage tank can be used in the collection of Oxygen and Argon and in capturing the separated or combined Natural Gas components enabling storing them as liquids with sufficient Liquid Nitrogen cooling to their containers to retain the liquid state.

### BRIEF DESCRIPTION OF THE DRAWINGS

Preferred exemplary embodiments of the invention are illustrated in the accompanying drawings in which like reference numerals represent like parts throughout, and in which:

FIG. 1 provides a vertical cross-sectional view of the exhaust pipe extension coming from the process where waste pure Nitrogen gas emerges at 190° C. or thereabouts. The traps to move the liquefied Nitrogen from the exhaust pipe extensions at the liquid surface.

FIG. 2 provides an image of the ball beads connected with a chain longer than the distance from the initial solid section of the parallel pipe through its entry into the trap pipe at the “T” section. The balls are spherical and hollow. The cutaway shows the chain connection to the balls in the trap pipe. These seal the passage of the Liquid Nitrogen preventing backflow of Liquid Nitrogen from the reservoir into the trap.

FIG. 3 provides the complete system with the ball beads installed in the trap system showing how they move pulling limited reservoir Liquid Nitrogen along with newly liquefied Nitrogen from the trap into the reservoir of Liquid Nitrogen, as the Liquid Nitrogen moves as shown in FIG. 3a, FIG. 3b, FIG. 3c, FIG. 3d and FIG. 3e.

FIGS. 4a and 4b show the ball valve design keeping Liquid Nitrogen from the reservoir from entering the exhaust pipe extension with normal flow in FIG. 4a and backflow prevented in FIG. 4b.

FIG. 4c shows the ball and socket joints between the exhaust pipe and exhaust pipe extension allowing the exhaust pipe extension to swivel to stay at Liquid Nitrogen surface with the first joint and for the exhaust pipe extension to swivel to keep the traps vertical.

FIG. 5 shows the cold sinks coming from the bottom of the Liquid Nitrogen in the reservoir bringing the cold to the exhaust pipe extension allowing more liquefication of the Nitrogen gas in the pipe. It lashes around the pipe to transfer the cold efficiently.

FIG. 6 shows a shovel net means to remove debris from the cryogenic reservoir. Skimming with the shovel net will remove debris floating on the surface.

FIG. 7 shows the light gas trap in the lid of the reservoir and a drop net means to remove debris from Liquid Nitrogen surface, floating in and on the floor of the reservoir.

FIG. 8 shows the trap for liquefied gas as it applies for gases that condense at higher temperatures than Liquid Nitrogen in the fuel harvest process and keeping it liquid.

### DETAILED DESCRIPTION OF THE PREFERRED EMBODIMENTS

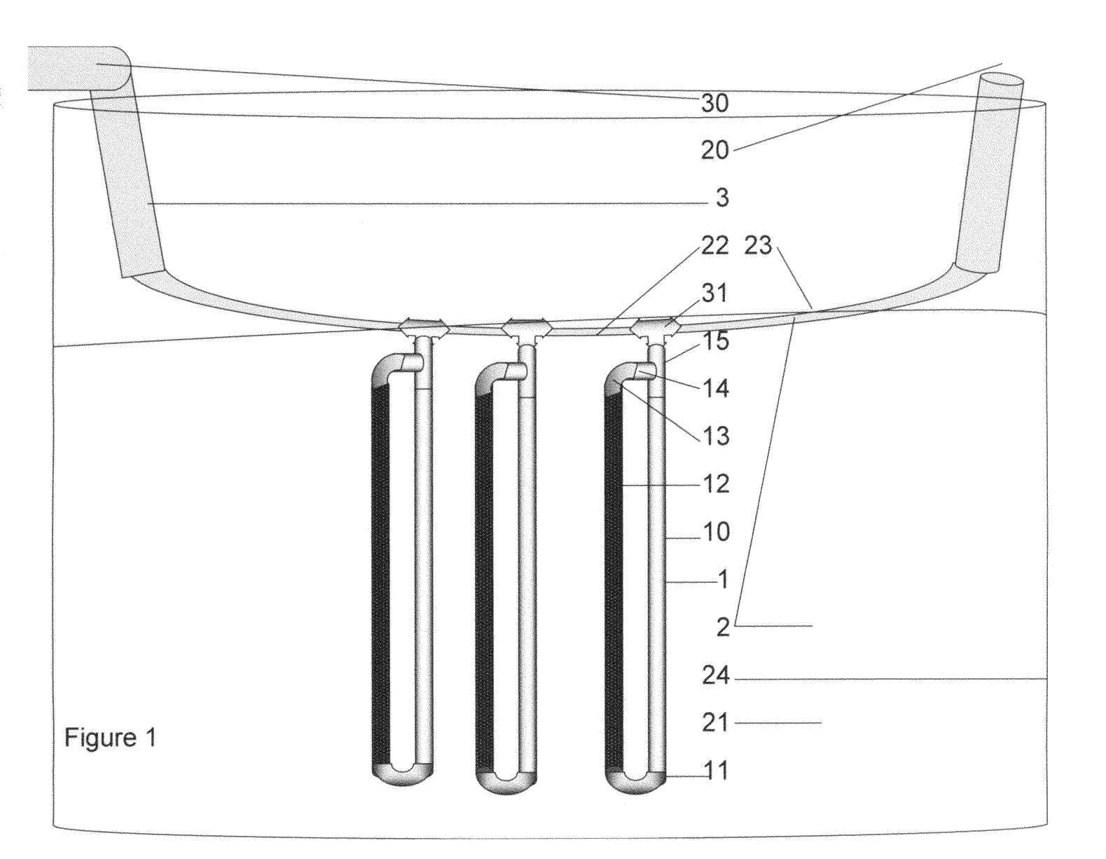

Turning now to the drawings and initially to FIG. 1, a method of bringing Liquid Nitrogen 2 condensed in the exhaust pipe extension 3 to the trap I flows forward as it condenses and approaches the trap and flows backwards to airflow returning to the trap(s) area 31 if it condenses as the pipe rises to exit the Liquid Nitrogen reservoir. The exhaust pipe extension carries gaseous Nitrogen 20 where a portion of it will liquefy. It enters the reservoir 24 where the −190° C. pure Nitrogen gas 20 leaves the condensing portion of the fuel extraction system 30, lays on the surface of the Liquid Nitrogen 23 and exits the exhaust pipe extension 3 after a reservoir diameter length out the top of the reservoir. The Nitrogen still in gaseous state 20 flows into the open air. Note the segments of the trap system 1, with the solid pipe 10 going vertically downward from the “T” 31 in the exhaust extension 3 towards the bottom of the Liquid Nitrogen reservoir 24, to the “U” of solid piping 11 at the bottom of the trap, to the pierced pipe area 12 parallel to the trap, to the solid elbow 13, the solid pipe 14 leading into the “T” 15 in the trap pipe 10. This creates a flow pattern to circulate the ball beads. Note the distance of solid pipe from the beginning of the elbow 13 to the entrance into the trap pipe 15 is significant because it holds the amount of reservoir Liquid Nitrogen 21 that flows with the newly liquefied Nitrogen 22 formed in the exhaust pipe extension 3.

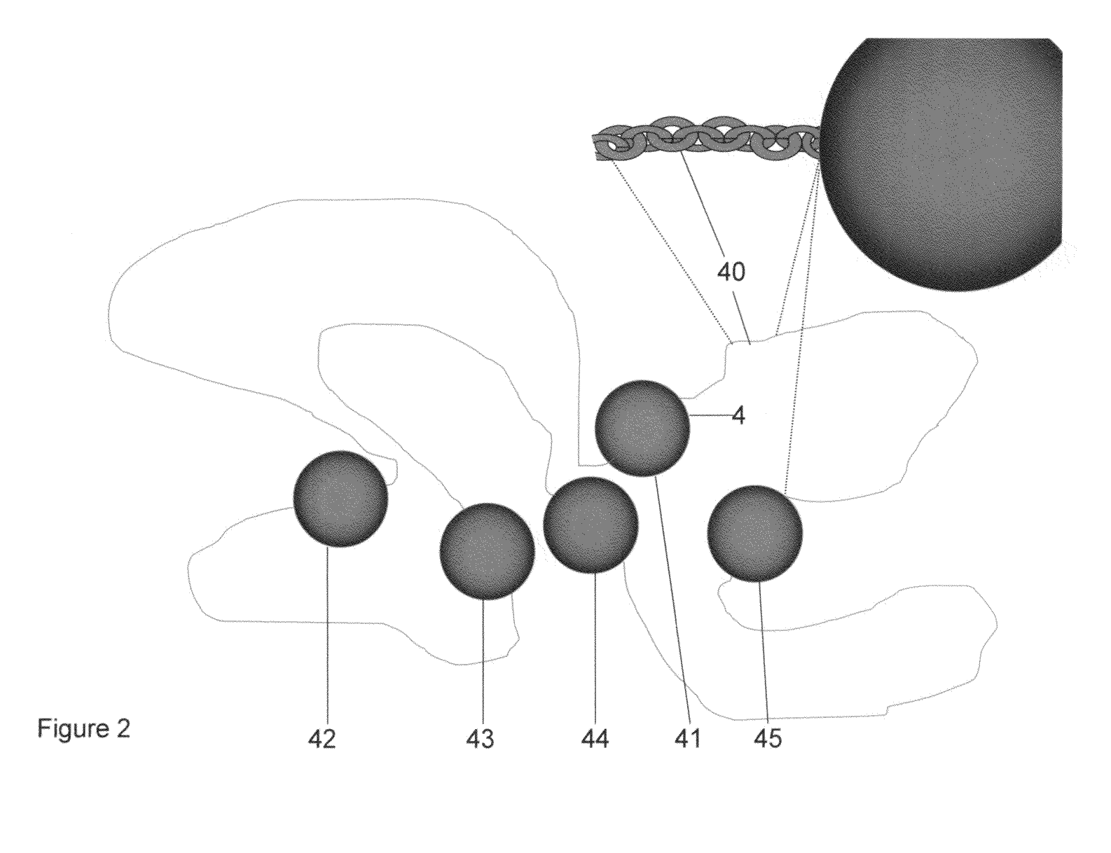

Viewing FIG. 2, the ball beads 4 are shown with the chain 40 separating them such that the chain is longer than the distance in FIG. 1 between the entrance to the elbow 13 to the entrance into the trap 15. This allows the ball beads 4 to block the entrance to the pipe 13 so no further Liquid Nitrogen enters the trap system. The chain 40 and its attachment to the ball surface shown magnified off ball 45 prevents the chain 40 from being pulled past the ball in the trap 1, keeping the chain 40 between the two balls it is attached to. Likewise, Liquid Nitrogen does not pass between the ball 4 and the pipe wall.

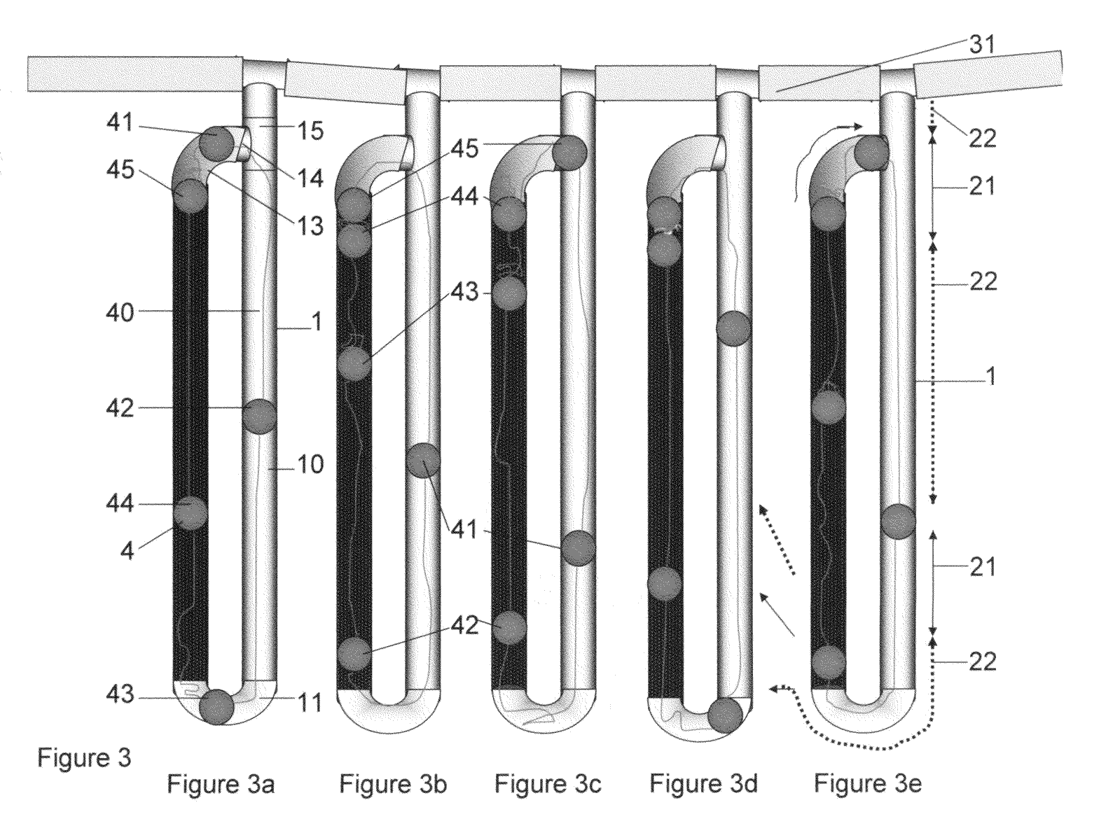

FIG. 3 shows the ball beads 4 and chain sections 40 installed in the trap system 1. Note, in FIG. 3a, as one ball bead 45 enters the solid pipe elbow 13 that it blocks the flow of Liquid Nitrogen into the system as ball bead 41 enters the trap system, FIG. 3b, the ball flows down the vertical solid trap pipe 10 stretching out the chain as it descends. As the chain 40 stretches to its full length, as ball 41 continues to descend it pulls ball 45 into the elbow 13 and along the short pipe 14 and ball 44 locks the entrance to the solid elbow 13 from reservoir sourced liquid Nitrogen 21, FIG. 3c. As ball 41 descends further, FIG. 3d, ball 45 is pulled into the trap and it descends extending the chain 40 between balls 45 and 44 until ball 43 is pulled into the elbow and seals the pipe at elbow 13 preventing further reservoir Liquid Nitrogen 21 from entering the trap 1, FIG. 3e. As the balls stretch apart in the trap 1, the newly liquefied Nitrogen 22 enters the trap below the “T” 15 emptying the newly Liquefied Nitrogen 22 from the exhaust pipe lower area 31 to flow with the reservoir sourced Liquid Nitrogen 21 caught between elbow 13 and “T” 15.

What features do these materials need for this cryogenic control system? First, the density of the balls including the chain lengths must be less than the density of Liquid Nitrogen which is 80% of that of water. And the pipe coefficient of expansion must be like that of the balls. One pair of materials that can qualify is using stainless steel pipe for both the solid and pierced portions and having hollow Beryllium—Aluminum alloy ball and chains. These are both dimensionally stable and rugged enough at cryogenic temperatures to not fail in use.

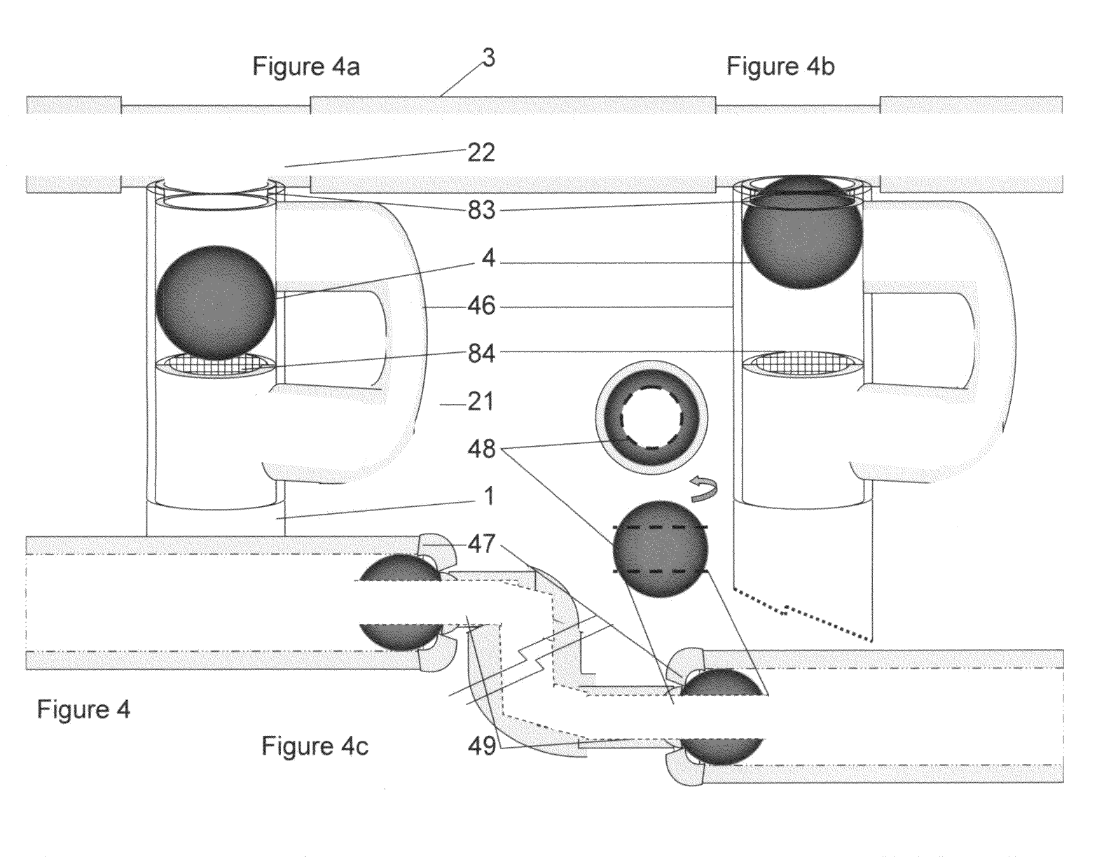

FIG. 4a shows the trap 1 connection valve 46 between the exhaust pipe extension 3 and the trap 1 during normal flow of the newly liquefied Nitrogen. FIG. 4b shows how regurgitation of the reservoir contained Nitrogen 21 into the extension 3 is prevented. This valve 46 consists of the ball bead 4 without a chain which sits on the net catch 84 allowing the newly liquefied Nitrogen 22 flowing into the vale 46 passing through on the “c” shaped piping. In FIG. 4b, the ball 4 is forced upward by reservoir sourced Liquid Nitrogen 21 preventing its flow back into the exhaust pipe extension 3 by sealing the entrance to extension 3 at the seating ring 83. Newly liquefied Nitrogen 22 in the exhaust extension 3 pushes the ball bead 4 down to rest on the net catch 84 as it enters the trap flowing around the ball in the “c” pipe of the valve 46 in FIG. 4a.

FIG. 4c illustrates the two ball and socket joints 47 needed at each the entrance of the exhaust pipe extension into the Liquid Nitrogen reservoir 24 and at the end of the pass over the surface of the Liquid Nitrogen 23 near where the remaining gaseous Nitrogen 20 exhausts into the atmosphere. The double ball socket joints have balls with passage 48 attached to the pipe section attached 49 fit into a 90° elbow. One ball 48 is in the exhaust pipe extension 3 entrance and exit pipes and the other is in the part of the pipe 31 passing low over the surface of the Liquid Nitrogen in the reservoir where the traps 1 are located. The first ball joint allows the lower pipe section 31 to ride on the surface of the Liquid Nitrogen 23 in the reservoir. The second ball joint allows the traps to extend vertically into the reservoir Liquid Nitrogen 21, and not at any other angle.

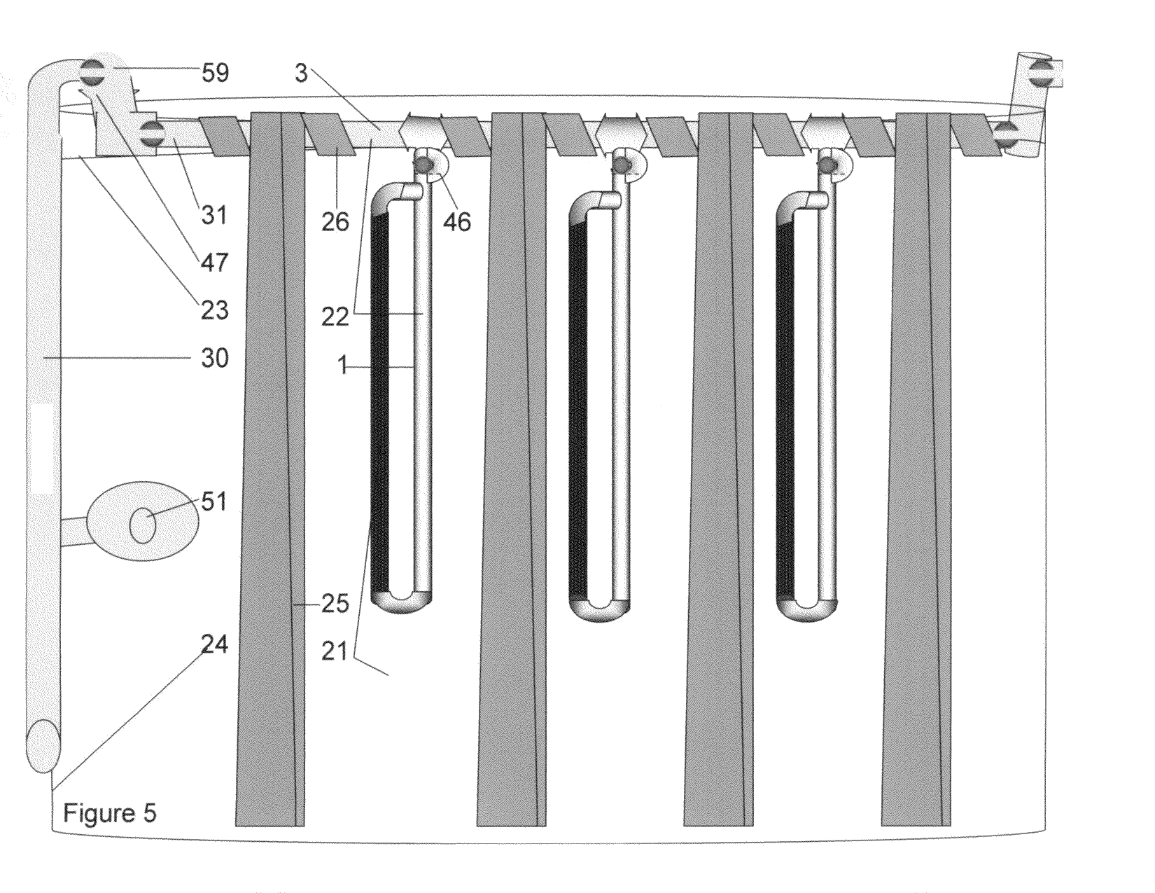

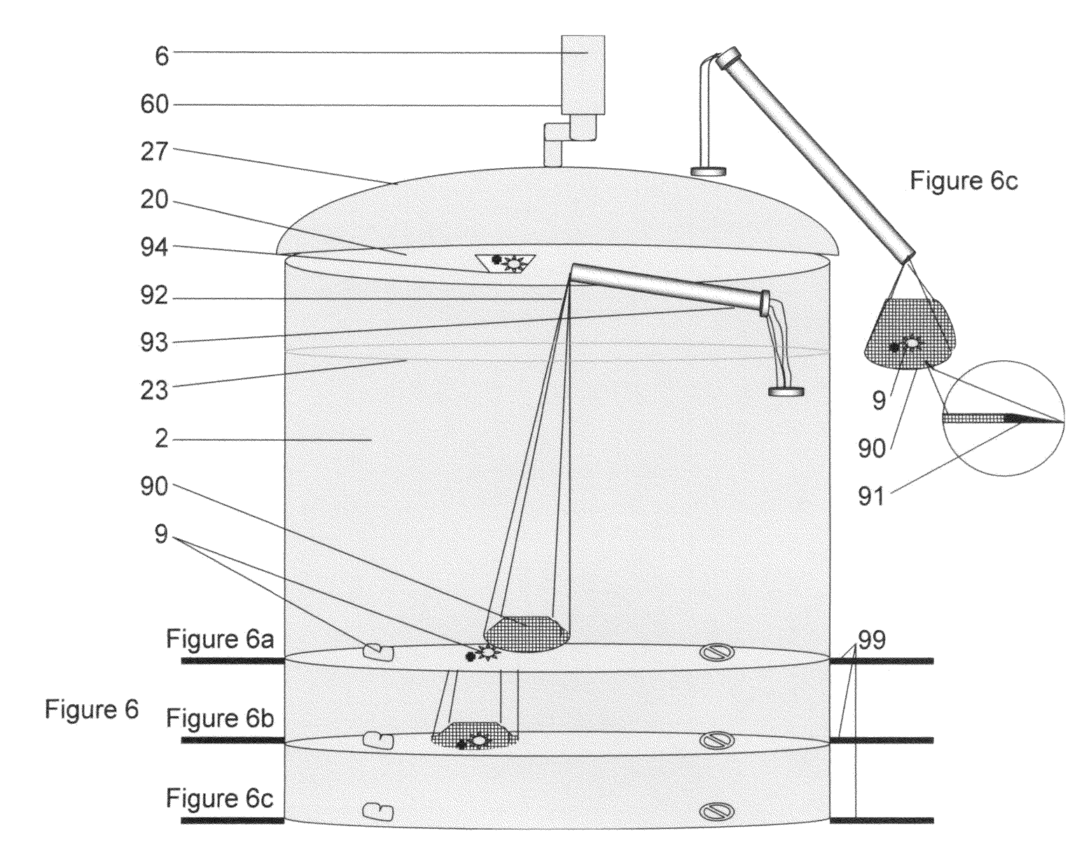

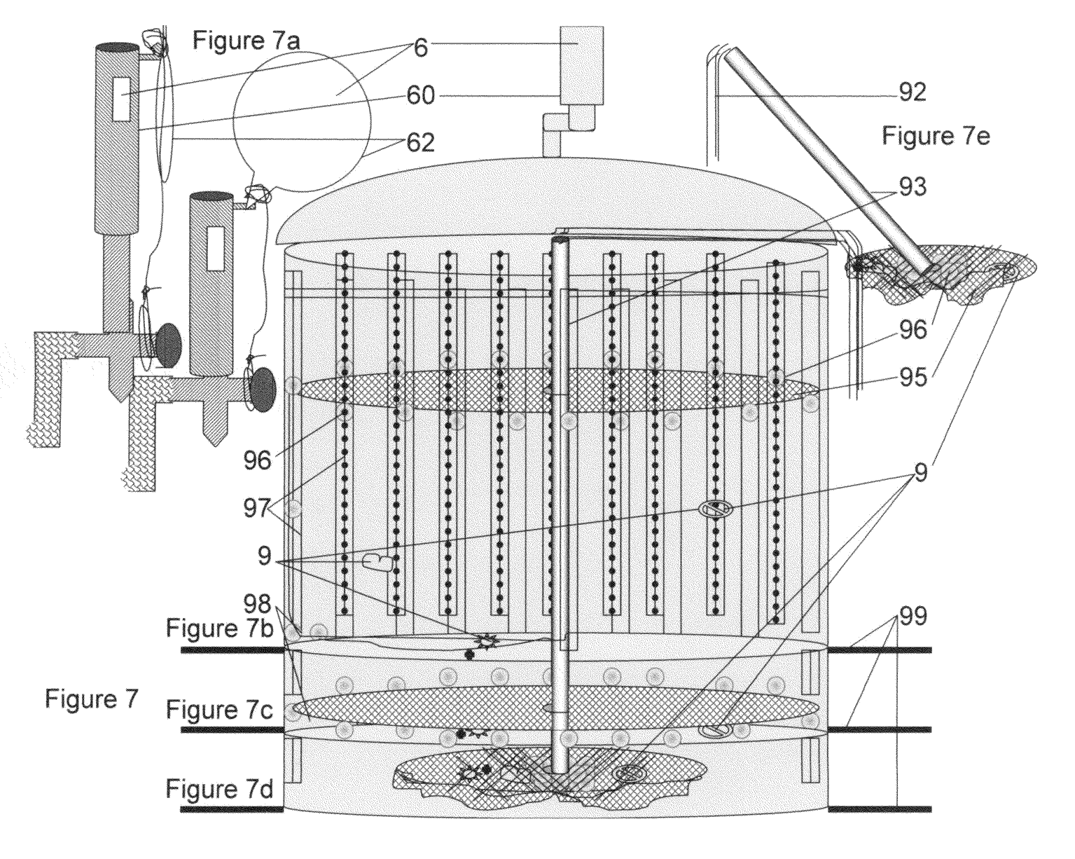

FIG. 5 shows this trap system in the beginning 51 and end 59 of the Fuel Extraction system 5, where the exhaust pipe 30 feeds into the exhaust pipe extension 3 and allows the gaseous Nitrogen 20 to flow through the extension 3 across the surface of the Liquid Nitrogen 23 where the traps 1 extend down in the reservoir 24 where its Liquid Nitrogen 21 is at and below −195.8° C. This can liquefy the gaseous Nitrogen 20 in the lower part of the extension 31 to form liquid Nitrogen 22. To enhance this process, it is believed that the Liquid Nitrogen 21 at the bottom of the reservoir 24 is colder than that at the surface because of the weight of the Liquid Nitrogen on top of it. Therefore cold sinks 25, copper plates, extend deep into the reservoir and are lashed 26 to the lower extension pipe 31 super cooling it to liquefy 22 more of the Nitrogen gas 20 as it passes through the exhaust system. Also illustrated here is the exit 51 of Liquid Nitrogen 21 from the reservoir to the Fuel Extraction System 5 and the entrance 59 of the exhausted Nitrogen gas 20. This Nitrogen gas 20 passes through the Exhaust Pipe Extension 3, through the double swivel ball joint 59, along the low section of the extension 31 where the cold sink lash 26 encircle the pipe lowering the temperature further, and the traps 1 are attached at “T” section and where the valves 46 keep the Reservoir Liquid Nitrogen 22 out of the exhaust system. On the exit end of the exhaust extension is the second ball joint which feeds remaining Nitrogen gas 20 into the atmosphere or inside the lid for one more pass through a light gas catch 60 shown in FIGS. 6 and 7.

FIGS. 6 and 7 show means of maintaining a clean Liquid Nitrogen reservoir.

FIG. 6 shows use of a net shovel 90 to remove debris 9 from the bottom or surface of the Liquid Nitrogen 2 in the reservoir 24. The net shovel 90 has a beveled edge 91 allowing it to get under loose debris 9 and move to have the debris come onto the net. The net section has two straight edges and two edges that are the same arc as the inner surface of the cylindrical reservoir. This way, if the debris is at the edge, the arc sides can capture it for removal. Parts of the shovel 90 include lines 92 that can raise and lower the net 90 from each corner and a pole 93 with line locks to control the planar angle of the shovel. This allows one to extend it over the surface to have the outer end just above the debris 9 to be removed and lower it to the right position to capture the debris. The mirror 94 helps one guide the net into position allowing viewing of the debris 9 and net edge 91 as the shovel 90 shoves under the debris allowing removal on the net surface. The bottom of the reservoir 99 is where these debris items are resting. FIG. 6a shows the initial approach of the net shovel 90; FIG. 6b shows its pushing under the debris; and FIG. 6c shows the debris removed from the floor of the reservoir 99 and, along with the lowest part of the reservoir, the other part of FIG. 6c is shown with the shovel 90 and the debris 9 out of the reservoir 24 of Liquid Nitrogen 2.

Also defined here are the Nitrogen gas 20 over the surface of the Liquid Nitrogen 2, the lid to the reservoir 27 and the light gas catch 60 with some captured Hydrogen, Helium and Neon, the light gases 6.

FIG. 7 tackles the problem of floating debris 9 where some can be settled on the bottom 99 and some floats mid-way in the Nitrogen and other debris floats on the Liquid Nitrogen 2. If this is a problem, the reservoir 24 can be fitted with tracks 97 mounted nearly to the bottom 99, but with enough room for escape space 98 for the heavy balls 96 which are attached around the drop net 95. The heavy ball tracks 97 are “c” shaped keeping the heavy balls in the track until they can escape at the bottom of the reservoir. The drop net captures the surface, floating and bottom debris as it drops and then is pulled closed by the lines 92 attached at each ball position that are gathered in the tube handle 93 and pulled out as far as possible before lifting the drop net from the bottom of the reservoir.

Defined here in FIG. 7 are, in FIG. 7a, the detailed light gas catch 60 with the light gases 6 on the feed pipe 61 and the capture means for the light gases 6, the mylar type balloon and string tie 62. This balloon is filled when one pushes the catch 60 down allowing the light gases 6 to pass into the balloon 62 which is then tied and replace with another balloon 62 for the next catch 60 full of light gases 6.

The sequence of capture of debris is shown in FIGS. 7b-7e where in FIG. 7b the net is fit over the surface and heavy balls 96 attached to the drop net 95 are placed in the tracks 97 and the drop net 95 lowers through the Liquid Nitrogen 2. In FIG. 7c the drop net 95 nears the bottom and the balls 96 are free from the track 97 escaping in the gap 98 between the end of the track 97 and the floor of the reservoir 99. In FIG. 7d, the lines 92 are pulled tightly so the heavy balls 96 gather at the base of the handle 93 capturing the debris items 9 in the drop net 95. In FIG. 7e, the drop net 95 and debris 9 are out of the Liquid Nitrogen 2 in the reservoir 24 and the material in the debris 9 disposed of. Since the temperature in the reservoir Nitrogen is −195.8° C. and lower, the debris items could well melt as they warm up suggesting that the net be over a containment or the solid debris be quickly placed in jars and sealed or, if it is know what the material is, like, for instance, water, it can be allowed to melt and then evaporate.

The pathway of the heavy balls 96 is illustrated in the far left track 97 where it lowers and escapes 98 from the track at the bottom 99 and then is pulled by the line 92 to the center where the handle tube 93 guides the line so the operator can pull the net circumference to the middle and then, holding the lines 92 locked close to the outer end, lifts the handle and drop net 95 with the heavy balls 96 and debris 9 out of the Liquid Nitrogen reservoir.

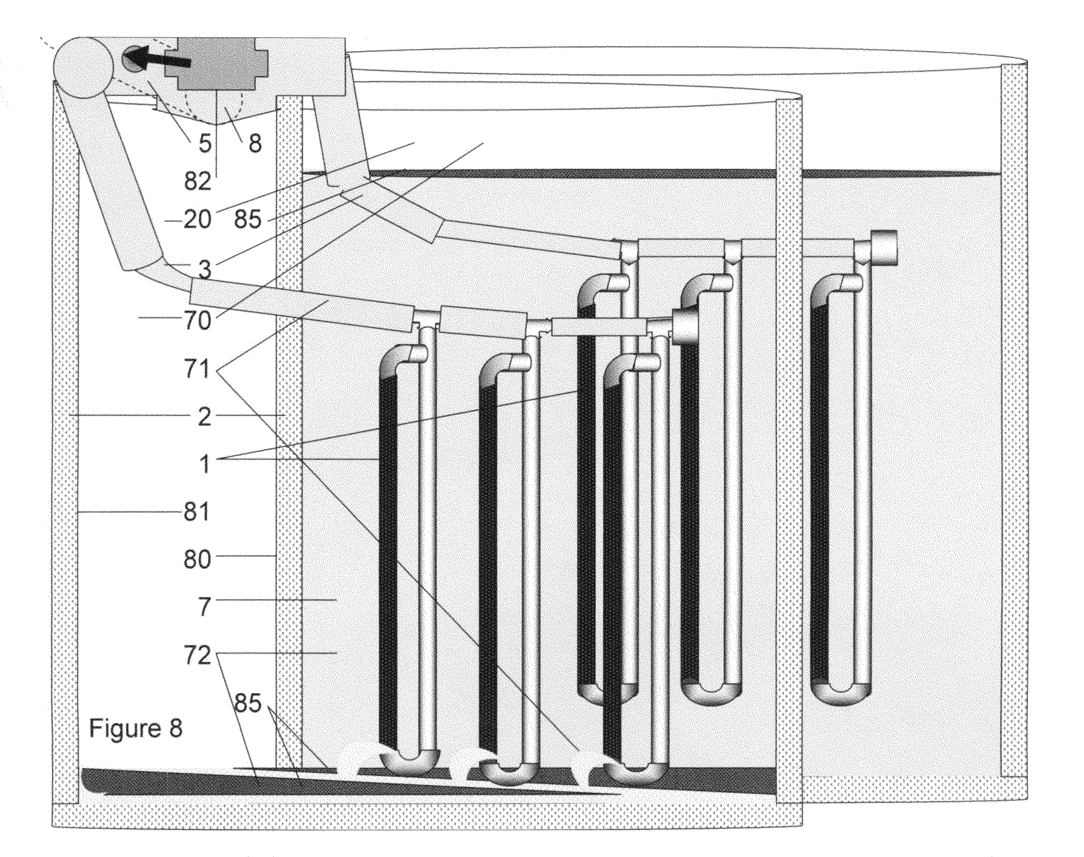

FIG. 8 shows the traps 1 serving to bring condensed material into their holding tanks where the exit 8 from the Fuel Extraction System 5. The containers for the material 80, 81 are surrounded and based on Liquid Nitrogen 2 and Nitrogen gas 20 and the gaseous state of the material 70 comprise the gases over the liquid material 7. The containers drawn to be transparent contain the liquid state material 72. New liquid material 71 is pouring into the presently empty vessel 81 through the traps 1 in the forward vessel. The vessel behind 80 was just filled and should be exchanged for an empty vessel and sealed for portage to the refinery. The switching mechanism 82 is triggered to change vessels to be filled by the height of the liquid in the container. The liquid 7 in container 80 has met that height requirement and is now ready for replacement. Note that these traps 1 are coming off submerged pipe extensions 3 to prevent long drops of the liquid material since it may cause some of the material to evaporate as it falls. Minimal drop means minimal evaporation of liquid form material 7. To prevent further evaporation in the tank, a film 85 is placed over the surface. The film material can be edge sealed “bubble plastic” with the bubbles on one sheet fitting between the bubbles of the other sheet. Having this film 85 in two parts, it can move upward on either side of the traps 1.

Once the reservoir 80 of the liquid material 72 is full, an empty reservoir 81 next to it begins to fill. A “T” valve 82 which will stop the flow into the full reservoir 80 allowing the remaining Liquid 7 to begin filling the next reservoir 81. The filled reservoirs 80 are stored at cryogenic temperatures below that of the liquid 7. Materials collected this way include the Natural Gas components of Butane, Propane, Ethane, and Methane, and common gases as Oxygen and Argon.

Many changes and modifications could be made to the invention without departing from the spirit thereof. The scope of some of these changes can be appreciated by comparing the various embodiments as described above. The scope of the remaining changes will become apparent from the appended claims.

Therefore I claim:

1. A method of liquefying cryogenically cold pure Nitrogen taking the following steps:
a) cooling it below liquefaction temperature of Nitrogen;
b) collecting the newly liquefied Nitrogen in the lowest portions of the pipe;
c) having one or more traps on the lowest portion of the pipe into which the Liquid Nitrogen can flow;
d) moving the Nitrogen through the trap with ball beads preventing backflow of Liquid Nitrogen from the reserve tank staying at the Liquid Nitrogen surface;
e) continuing the movement of the chain connected ball beads pulling with their passage through the trap system carrying more and more of the newly formed Liquid Nitrogen into the Liquid Nitrogen reservoir; and
f) allowing the remaining gaseous Nitrogen that has not condensed to exhaust into the atmosphere or into the lid of the reservoir.

2. The method according to claim 1 where the trap is comprised of a solid pipe vertical from the “T” pipe in the exhaust pipe extension in the lowest section of that pipe down to a “U” pipe that is also solid walled, feeding into a vertical pipe parallel to the entry pipe which is pierced with holes smaller than the beads and the chain so they cannot pass through but does allow the incoming Liquid Nitrogen to depart from the trap, and which connects to a solid elbow with a solid mating tube to a “T” feeding in the vertical solid pipe of the trap allowing flow of the Liquid Nitrogen and the balls through the pipes around the course of the pipe loop comprising the trap.

3. The method according to claim 2 where the ball diameter is the same as the interior diameter of the trap pipes so there is no backflow of reservoir Liquid Nitrogen through the trap and into the exhaust pipe extension.

4. The method according to claim 2 where the chain is attached to the ball surface such that it holds the chain end securely and neither the chain or the attachment to the ball will fit into the openings in the pierced tubing of the tubing parallel with the trap entry tube.

5. The method according to claim 2 where the series of balls are held together by lengths of chain longer than the distance from the elbow to the center of the “T” pipe fitting at the top of the trap allowing the difference in lengths to be the length of the pipe that the newly condensed Liquid Nitrogen fills with the passage of each ball around the trap course.

6. The method according to claim 5 where the length of the chain connecting the balls in the ring are shorter than the distance from the elbow entrance before the “T” and the lower end of the trap pipe before the “U” at the bottom.

7. The method according to claim 1 where the ball bead and chain loop moves around the trap system to carry the reservoir Liquid Nitrogen that accumulated in the solid tubes between the elbow entrance and the “T” intersection with the solid vertical pipe to allow an additional quantity of Liquid Nitrogen between the balls passing down the trap to empty some of the newly liquefied Nitrogen from the exhaust pipe space into the reservoir of Liquid Nitrogen.

8. The method according to claim 1 that prevents the backflow of Liquid Nitrogen into the exhaust pipe extension because the mass of the bead balls is considerably less than that of the Liquid Nitrogen in the reservoir such that they float up the pierced tube blocking the entrance to the solid elbow preventing further Liquid Nitrogen from entering the trap system.

9. The method in claim 1 whereby a valve at the entry of the trap prevents backflow of Liquid Nitrogen in the reservoir into the exhaust tube extension stopping the positive flow.

10. A method of cryogenic tank maintenance allowing removal of debris with a net system guided by lines running through a handle such that it can be pulled under the debris and the debris taken to the surface and out of the reservoir.

11. The method according to claim 10 using a net shovel with straight and curved surfaces matching that of the reservoir edge with edges beveled to hug the bottom when laid flat which collects surface and bottom settled debris.

12. The method according to claim 10 using a drop net introduced from above the surface by heavy balls attached to the edge of the net that are carried to the bottom of the reservoir in vertically mounted tracks that end just higher than the diameter of the ball from the bottom allowing the balls to leave the tracks and be pulled by lines from their locations on the edge of the net to the tube handle where they can be pulled to gather the balls at the far end of the tube handle and include the items of debris caught in the net, which is then pulled from the reservoir and the debris contained with polluting melting and evaporating materials released into jars that are sealed to prevent open release of the material.

13. A method of preventing evaporation of other light gases at cryogenic temperatures by placing the liquefied material in the liquid portion of the storage tanks and covering a tank well filled with a film over the surface so the liquid doesn't interface with its gas.

14. The method according to claim 13 which allows switching from an already filled tank of the liquefied material to filling an empty vessel with the same type of trap using a valve which changes the flow of gas or liquid from the first to the next vessel, and once the full vessel is replaced with an empty one, the valve can then switch from the now filled second vessel back to fill the empty vessel placed at the initial location, alternating vessels as the filled ones are removed and replaced by empties.

15. A method to simplify the restoration to liquid state pure cryogenic temperature gases to make cryogenic processes less costly in materials required by recycling the exhaust of already pure gases and limiting the exposure of the liquid forms of the material with the gas form pulling more of the material to the gas form.
